(19) United States
(12) Patent Application Publication
(10) Pub. No.: US 2025/0011141 A1
(43) Pub. Date: Jan. 9, 2025

(54) REMOTE CONTROL SYSTEM

(71) Applicant: GOGOH CO., LTD., Kasugai-shi (JP)

(72) Inventors: Kouji OGAWA, Aichi (JP); Teruhiko SAWADA, Aichi (JP)

(21) Appl. No.: 18/890,494

(22) Filed: Sep. 19, 2024

Related U.S. Application Data
(63) Continuation of application No. PCT/JP2023/006339, filed on Feb. 22, 2023.
Application No. PCT/JP2023/006339 is a continuation-in-part of application No. PCT/JP2022/013034, filed on Mar. 22, 2022.
(63) Continuation-in-part of application No. PCT/JP2022/013034, filed on Mar. 22, 2022.

(51) Int. Cl. B66C 13/40; B66C 13/46

(52) U.S. Cl. CPC B66C 13/40; B66C 13/46

(57) ABSTRACT

Remote control of a moving object such as an overhead crane is provided with both safety and responsiveness/workability. A display is attached to a hoist of an overhead crane, and wall display units are attached to walls of the building. The crane can be operated in a plurality of operation modes. A pre-movement notice mode is a safe operation mode in which a direction of movement is displayed on the display units when movement is indicated using a direction button on a remote controller, and movement starts after a predetermined amount of time has elapsed or some type of movement instruction is given. An immediate movement mode is an operation mode having excellent responsiveness/workability in which movement is started immediately without a prior notice. The remote controller is provided with a mode switching button for switching between operation modes, thereby enabling switching between a plurality of modes.

### CLAIM OF PRIORITY

This application is a Continuation of International Patent Application No. PCT/JP2023/006339, filed on Feb. 22, 2023, which is a Continuation-in-Part of International Patent Application No. PCT/JP2022/013034, filed on Mar. 22, 2022. This application is also a Continuation-in-Part of International Patent Application No. PCT/JP2022/013034, filed on Mar. 22, 2022. The entire contents of each of the above-mentioned applications are hereby incorporated by reference.

### BACKGROUND OF THE INVENTION

### 1. Field of the Invention

The present invention relates to a technique for remotely controlling the movement of a movable object by wire or wireless.

### 2. Description of the Related Art

In facilities such as factories and warehouses, overhead cranes are used to transport heavy objects. The overhead crane transports the suspended load by moving the hoist, trolley, and other lifting devices for suspending the suspended load horizontally along the traveling and transverse rails provided in the facilities. The operation of the crane may be operated from the control room, but it is usually controlled remotely from the ground by an operator using a controller.

As a method for improving safety in an overhead crane, Japanese Patent Publication No. 2010-254417 discloses a technique for providing a display device indicating the direction of movement of the crane. Further, International Patent Publication No. WO 2013/114737 discloses a pre- movement notice that the crane starts moving after several seconds have elapsed after displaying the movement direction. By applying these technologies, it is possible to suppress accidents such as the crane moving in an unintended direction due to an operating error and colliding with the operator.

### SUMMARY OF THE INVENTION

However, while the pre-movement notice can improve the safety of the crane, it also reduces the responsiveness and workability because the crane does not move until a predetermined time has elapsed after the direction of movement is displayed. For example, if the suspended load swings when the crane is stopped, the swing can be absorbed by moving the crane by slight movement to forward as a trailing notch and backward as a reverse notch, but when a pre-movement notice is applied, such a quick response may be hindered. In addition, even in fine adjustment of the position when stopping the crane, if a pre-movement notice is displayed every when the crane is moved, it will take unnecessary time for fine adjustment.

Thus, it has been difficult to achieve both safety and, responsiveness or workability with conventional technology. Such a problem was not only to overhead cranes, but was a common problem for various types of cranes that can be operated remotely. In addition, it was a common problem not only for transporting heavy objects, but also cranes for nursing care, for example. Furthermore, it was a common problem not only for cranes but also for various remotely controlled mobile objects.

Consideration of such problems, an object of the present invention is to enable both safety, and responsiveness or workability when remotely controlling a movable object.

One embodiment of the present invention provides a remote-control system for remote-control of a movable object by wire or wirelessly, comprising (a) a remote controller for remotely controlling movement of the object, (b) a display unit, provided visibly to an operator who performs the remote-control, displaying an indication relating to the movement of the object, (c) a system control device for controlling the movement of the object and the display of the display unit, according to the operation of the remote controller, wherein the system control device has a plurality of operation modes switchable therebetween and different from one another with respect to presence or absence of a pre-movement notice before the movement and/or a condition to start moving the object.

According to one embodiment of the present invention, the plurality of operation modes can be switched according to the operation of the remote controller. The plurality of operation modes differs in the presence or absence of a pre-movement notice before movement and conditions to start movement. Regarding the pre-movement notice, a pattern of starting movement after making a pre-movement notice, a pattern starting movement without pre-movement notice, and the like are conceivable. As for the movement start conditions, a pattern in which movement is started immediately by an indication of the direction of movement, a pattern in which movement starts after a pre- movement notice is performed for a certain period, and a pattern in which movement is started by performing some operation after the pre-movement notice is performed. In the present invention, two or more arbitrary operation modes determined by these combinations are prepared, and they can be switched.

The requirements for safety, responsiveness, and workability of cranes vary depending on the situation in which the crane is operated and the skill of the operator. For example, when starting to move a heavy load or when the skill of the operator is relatively low, safety is emphasized. On the other hand, when the crane is to be stopped, high responsiveness is required when operations such as a trailing notch or reverse notch are required to prevent the swaying of the suspended load. Therefore, in a single operation mode, it is difficult to meet the requirements safety, responsiveness, workability, etc. according to all situations. On the other hand, in the present invention, since these plurality of operation modes can be switched, it is possible to satisfy requirements such as safety, responsiveness, and workability depending on the situation.

In accordance with one embodiment of the present invention, the movable object can be such as overhead cranes and other cranes, nursing care cranes, automated guided vehicle (AGVs), drones, and the like.

The display unit may be provided visibly from the operator, and one or both the display unit installed on the movable object itself and the display unit installed in the building or other space where the object is used can be used. The display content may represent the direction of movement of the object as an arrow or the like, or may be expressed in a direction such as east, west, south, north, etc. This display may be performed only for the pre-movement notice, or may be performed while moving. When performing while moving, the display mode such as color, brightness, and flashing may be changed between the pre-movement notice and the display during movement.

The switching of the plurality of operation modes may be performed by the operation of the remote controller, the setting switch of the remote controller, or the like, or may be automatically switched according to predetermined conditions related to the movement of the crane.

In accordance with one embodiment of the present invention, the plurality of operation modes may include a first pre-movement notice mode in which displaying the movement direction of the object on the display unit according to the operation of the remote controller, passing a predetermined time, then moving the object.

According to the above embodiment, since the movement direction is displayed in advance before moving, it is possible to avoid the object from moving in the wrong direction, and safety can be improved. In addition, since there is a grace period after the time the direction is given to the time when the object starts moving, the object can be stopped if the operator makes a mistake, ensuring a high level of safety. On the other hand, since there is no need to perform any operation further after the direction indication is given, the operation is simple.

In the first pre-movement notice mode, the predetermined time from the display on the display unit to the moving of the object can be set arbitrarily, preferably set to several seconds as the time required to confirm the pre-movement notice. The predetermined time may be fixed or adjustable. Furthermore, a plurality of operation modes may be provided, such as a first short pre-movement notice mode in which the predetermined time is set a short time and a first long pre-movement notice mode in which the predetermined time is set a long time.

In accordance with one embodiment of the present invention, the plurality of operation modes may include a second pre-movement notice mode in which displaying the movement direction of the object on the display unit according to the operation of the remote controller, receiving an operation instruction, then moving the object.

According to the above embodiment, since the pre-movement notice is performed according to operation of moving direction, a high level of safety can be ensured in the same level as the first pre-movement notice mode. In addition, since the object can be moved at any time after the pre-movement notice, the object can be moved quickly and work efficiency can be improved. Conversely, since it is possible to take sufficient time to confirm safety after the pre-movement notice, safety can be further improved.

When the second pre-movement notice mode is included, the operation instruction may be performed by operating the operation unit of the remote controller.

By using the remote controller for operation instructions, the efficiency of the operator can be improved. The operation unit may be buttons, sticks, and the like. The operation instruction includes, for example, pressing or releasing a button. However, it is not limited to these. The operation instruction may be, for example, pressing the button indicating the direction again, or pressing it deeply. In this way, it is easy to avoid operation errors because the same button indicating the direction is used for the operation instruction.

Further, an operation unit for operation instructions may be provided separately from the buttons indicating the operation directions. For example, a pre-movement notice may be displayed when an operation direction is indicated while the operation instruction button is being pressed, and then movement may start when the operation instruction button is released. Conversely, a pre- movement notice may be displayed when an operation direction is indicated, and then movement may be started when the operation instruction button is pressed.

In any embodiments, it is preferable to ensure that the operation instruction is valid only when the pre-movement notice is properly performed. This can improve safety.

In accordance with one embodiment of the present invention, the plurality of operation modes may include an immediate movement mode in which moving the object immediately according to the operation of the remote controller.

According to this embodiment of the present invention, since the immediate movement mode does not perform the pre-movement notice, the responsiveness and workability of the object can be improved. The immediate movement modes are useful when trailing notching, reverse notching, etc. is performed, especially when responsiveness is required.

In accordance with one embodiment of the present invention, the system control device may display the movement direction of the object on the display unit even in the immediate movement mode. That is, unlike the pre-movement notice, the direction of movement is displayed at the same time as the start of movement or after the start of movement. Such a display has the effect of notifying the operator of the error of the operation and notifying the people around the suspended load of its movement, which can improve safety in the immediate movement mode.

In accordance with one embodiment of the present invention, the system control device may switch between (a) a pre-movement notice mode in which displaying the movement direction of the object on the display unit according to the operation of the remote controller, then moving the object when a start condition is satisfied, and (b) an immediate movement mode in which moving the object immediately according to the operation of the remote controller.

According to the embodiment, when high safety is required, a pre-movement notice mode can be used, and when responsiveness and workability are required, an immediate movement mode can be used, so that safety, responsiveness, and workability can be achieved according to the situation.

The above-described pre-movement notice mode may be one or both the first pre- movement notice mode and the second pre-movement notice mode described above.

In accordance with one embodiment of the present invention, the system control device may switch between (a) a first pre-movement notice mode in which displaying the movement direction of the object on the display unit according to the operation of the remote controller, passing a predetermined time, then moving the object, and (b) a second pre-movement notice mode in which displaying the movement direction of the object on the display unit according to the operation of the remote controller, receiving an operation instruction, then moving the object.

The advantage of the first pre-movement notice mode is, since the object moves automatically without any operation, that it is difficult to make an error in the operation at the start of the movement. On the other hand, the advantage of the second pre-movement notice mode is that the object can be moved at any timing. The above embodiment, by making it possible to switch between the two modes, is possible to utilize the advantages of both while ensuring safety by the pre-movement notice.

In accordance with one embodiment of the present invention, the system control device may switch between (a) a first short pre-movement notice mode in which displaying the movement direction of the object on the display unit according to the operation of the remote controller, passing a first predetermined time, then moving the object, and (b) a first long pre-movement notice mode in which displaying the movement direction of the object on the display unit according to the operation of the remote controller, passing a second predetermined time longer than the first predetermined time, then moving the object.

According to this embodiment, the time after displaying the movement direction of the object to the actual start of movement of the object can be varied depending on the environment or the operator of the object, which ensures safety and workability suitable for the situation. The first and second predetermined times may be fixed in advance or may be arbitrarily set by the operator. Further, in the first pre-movement notice mode, more operation modes may be provided with different times until the start of movement.

In accordance with one embodiment of the present invention, the remote controller may have a switching unit to switch the plurality of modes separately from the operation unit that operates the object. In this way, it is possible to separate the normal operation from the operation or setting for switching operation modes. Therefore, when operation mode switching is not required, the operator can operate the object without being aware of it, and can suppress an operation error.

The switching unit for mode switching can be provided in various aspects. For example, a switching unit may be such as a switch, button, lever, or the like used for switching. In this way, the operation mode can be switched relatively easily. Further, the switching unit may use a dip switch, a slide switch, a jumper pin, a jumper wire, or the like provided inside or outside the remote controller. In this way, it is possible to suppress the possibility that the operation mode is accidentally switched during operation.

A controller other than the remote controller for operating the object may be used, and for example, a mobile terminal such as a smartphone may be used for switching operation modes or operating the object. Furthermore, when a mobile terminal capable of switching a screen such as a smartphone is used as a remote controller, the screen for operating the object and the screen for switching operation modes may be separated.

When the operation of the object is performed with the right hand, an operation unit is provided assuming that the operation mode is switched with the left hand, that is, the operation mode may be switched with the hand opposite to the operation of the object. By doing this, mode switching can be performed without hindering the operation of the object, and the possibility of mode switching being performed incorrectly can be suppressed.

The operation mode may be switched by an operation such as shaking the remote controller itself or grasping it strongly.

In accordance with one embodiment of the present invention, the system control device may switch from one operation mode to another operation mode when a predetermined condition is satisfied. A predetermined condition means a condition other than the operation of the remote controller. According to the above aspect, since the operation mode is automatically switched without manually switching the operation mode, the work efficiency is improved. There is also an advantage of avoiding forgetting to switch operation modes.

In case of switching the operation mode automatically, the predetermined condition may be that there is no remote-control operation for a predetermined time after when the object finishes moving and stops.

As an example where nothing is operated in the predetermined time after the movement is completed, it is considered that the crane has finished transporting the suspended load and is in a standby state. Therefore, the operation mode is preferably set to an operation mode suitable for the start of the next new operation. According to the above aspect, there is an advantage that the operation mode can be automatically switched without any operation by the operator.

In the above embodiment, the remote-control system my switch the operation mode, when the predetermined conditions are satisfied, to a pre-movement notice mode in which displaying the movement direction of the object on the display unit according to the operation of the remote controller, then moving the object when a start condition is satisfied.

From the viewpoint of safety, it is basically desirable to operate in the pre-movement notice mode, but if the operation mode is switched manually each time, it is assumed that the operator who was operating in the immediate mode will forget to switch to the pre-movement notice mode after completing the operation in the immediate mode. In this case, if it is automatically switched to the pre- movement notice mode under the condition of there is no operation at a predetermined time after the object stopped moving, the operation mode will be switched to the pre-movement notice mode by the time when the next operation of the object is performed, and thus safety is ensured.

In case the operation mode is switched automatically, the predetermined condition may be that an remote-control operation has been performed within a predetermined time after stop the movement of the object.

Such situations include a scene immediately after the crane transports the suspended load to the destination, a scene where the operator found the direction instruction is incorrect at the beginning of the transportation of the suspended load, and a situation where the movement is stopped temporarily after the movement is started, and the surrounding safety is checked and the movement is continued. According to the above embodiment, there is an advantage that the operation mode can be switched according to these scenes without an operation of the operator. In the above embodiment, the remote-control system may switch the operation mode, when the predetermined conditions are satisfied, to an immediate movement mode in which moving the object immediately according to the operation of the remote controller. According to the above embodiment, when the operator stops the operation and re-starts the operation within a predetermined time, the operation mode is switched to the immediate movement mode. It is especially useful when the next operation should be done immediately, for example, like the trailing notch.

In accordance with one embodiment of the present invention, the system control device may switch to another operation mode among the plurality of modes even while operating in another operation mode among the plurality of operation modes. According to this embodiment, for example, the operation mode is switched to the immediate movement mode after the pre-movement notice is displayed in the pre-movement notice mode, the object can be moved promptly without waiting for a predetermined time to elapse. Therefore, while ensuring safety, responsiveness and workability can be improved.

Furthermore, in the above embodiment, in order to ensure minimum safety, the conditions under which switching to the immediate movement mode may be limited. For example, a switchable time shorter than a predetermined time from the display to movement to the movement may be set, and after the pre-movement notice is made in the pre-movement notice mode, switching to the immediate movement mode may be prohibited unless the switchable time has elapsed. By doing so, it is possible to secure a minimum time to check the pre-movement notice. In the sense of securing such time, the operation for switching from the pre-movement notice mode to the immediate movement mode may be a complex operation that requires time.

In accordance with one embodiment of the present invention, an operation of the remote controller to determine the movement direction of the object may also be an operation to start the movement of the object.

The remote controller for overhead cranes has buttons corresponding to the direction of movement from north, south, east, and west, and when one of the buttons is pressed, the object starts moving. That is, the instruction in the direction of movement is at the same time an instruction to start the movement of the object. With such a remote controller, there is a high possibility that an accident will occur if the direction of movement is wrong. Therefore, the usefulness of the present invention is particularly high.

However, the present invention is not limited to such a type of remote controller, but can also be applied to another type of remote controller in which an instruction in the direction of movement and an instruction to start moving the object are separated. For example, such a remote controller may have separate buttons corresponding to the north, south, east, and west to indicate the direction of movement, and another operation start button to be pressed to start a movement of the object, and the like. The direction of movement can be indicated by various methods such as by rotating a part of the remote controller, directing the remote controller itself in the direction of movement, and providing a handle or stick for instructing the direction of movement.

In these remote controllers, when the direction of movement is indicated, the display of the direction of movement may be started. When this display is performed as a pre-movement notice, the instruction to start movement may be effective after a predetermined time has elapsed after the display starts.

In accordance with one embodiment of the present invention, the system control device may principally, as a default or primary operation mode, perform a first pre-movement notice mode in which displaying the movement direction of the object on the display unit according to the operation of the remote controller, passing a predetermined time, then moving the object. In this embodiment, the first pre-movement notice mode is the default operation mode.

In accordance with one embodiment of the present invention, the system control device may principally, as a default or primary operation mode, perform a second pre-movement notice mode in which displaying the movement direction of the object on the display unit according to the operation of the remote controller, receiving an operation instruction, then moving the object. In this embodiment, the second pre-movement notice mode is the default operation mode.

According to this embodiment, since it operates in the first pre-movement notice mode or the second pre-movement notice mode during normal operation, safety can be improved. Such embodiments are particularly useful when an accident due to an operation error is likely to be serious, for example, a movable object carrying a heavy load.

In accordance with one embodiment of the present invention, the system control device may principally, as a default or primary operation mode, perform an immediate movement mode in which moving the object immediately according to the operation of the remote controller. According to this embodiment, responsiveness and workability can be improved because the object can be moved quickly. On the other hand, since other operation modes such as the pre-movement notice mode can be used together as necessary, safety can be improved.

Such an embodiment is useful even if an operation error is made, when it is unlikely to lead to a serious accident, for example, a movable object carrying a lightweight load, a movable object having a slow speed, a movable object operating in a place where there are no surrounding obstacles that can collide with.

In accordance with one embodiment of the present invention, the system control device may switch the default operation mode among the plurality of operation modes. In this way, the default operation mode can be switched according to the operation situation, so that it can be operated efficiently while ensuring safety, responsiveness, and workability.

In accordance with one embodiment of the present invention, the display unit may be installed and movable together with the object. Since the operator normally operates while visually recognizing the object, the usefulness of the display according to the embodiment is high.

In accordance with one embodiment of the present invention, the display unit may be fixed apart from the movable object, to any part in the space where the object moves. The display unit may be installed on the wall of the building, or may be supported in the space using a support column or the like. The display unit fixed in the space in this way is easy to see by the persons other than the operator of the object, and has the advantage of improving safety for these persons. In such a respect, it is preferable that the display unit fixed in the space is of a size that is easy to see from a distance. The display unit may use either one of the one can be moved with the object or the one fixed in the space, or may be used in combination.

When using a display unit fixed in space in this way, a plurality of the display units may be installed corresponding to the movable direction of the object, and the system control device may make a display unit installed at a position corresponding to the direction of movement according to the operation of the remote controller react. The reaction of the display unit refers to displaying or flashing only on a specific display unit.

For example, when the direction of movement is determined to be east, west, north, and south such as an overhead crane, the display unit may include a plurality of displays installed in respective directions of walls of the building. If it is possible to move in 8 directions, the displays can be installed in the 8 directions.

When display units corresponding to the direction of movement are installed in this way and the direction of movement is indicated as, for example, “east”, the display unit installed in the east is reacted. The same applies when other directions of movement are indicated. In this way, by reacting only a part of the display units, safety can be improved because it is easy to attract the attention of the operator.

In particular, when operating the object carrying a heavy load, the operator usually stands behind or diagonally behind the object, that is, the object stands on the opposite side of the movement direction and operates while visually observing the object. In such an embodiment, when the direction of movement is correctly indicated, the frontal indicator visible at the end of the object should respond. Conversely, when the front indicator does not respond, there is a possibility that the direction of movement is incorrectly indicated. Thus, the above embodiment has the advantage that the appropriateness of the indicated direction of movement can be easily determined when considering the normal operation method of the object. Even if the contents of the display unit cannot be read, safety can be further improved in that it can be judged only by the presence or absence of a response.

However, when a display unit fixed in a space is used, it is not intended to exclude other aspects. A display installed in a location other than the position corresponding to the direction of movement may be reacted. Further, the direction of movement may be displayed on all displays. The indicator can be used in various aspects.

The present invention is applicable to various movable objects, and it is useful when the movable object is an overhead crane. The present invention does not necessarily have all of the above-described features, and may optionally omit or combine some of them.

The present invention can also be implemented in an embodiment other than the remote-control system. For instance, a remote-control method for remote-control of a movable object by wire or wirelessly, may be provided. Such a method may comprise, as steps that the computer performs, (a) receiving a signal for the movement of the object from a remote controller for the remote- control, (b) displaying an indication relating to the movement of the object on a display unit provided visibly to the operator who operates the remote controller according to the received signal, (c) controlling the movement of the object and the indication on the display unit according to an operation of the remote controller and an operation mode which is one of a plurality of operation modes different from one another with respect to at least one of presence or absence of a pre-movement notice before the object is moved, and a condition to start moving the object, the controlling including: switching among the plurality of operation modes.

Furthermore, an embodiment of the present invention may be configured as a computer program for causing a computer to perform such a remote-control method, or a computer readable recording medium that records the computer program.

In these various embodiments, various features described in the remote-control system can be appropriately applied.

### BRIEF DESCRIPTION OF THE DRAWINGS

The present invention is illustrated by way of example, and not by way of limitation, in the FIG.s of the accompanying drawings and in which like reference numerals refer to similar elements and in which:

FIG. 1 is an explanatory diagram showing the configuration of a crane system in accordance with one embodiment of the present invention.

FIG. 2 is an explanatory diagram showing an example of the display of the crane system.

FIG. 3 is a flowchart of the immediate movement default mode control process in accordance with one embodiment of the present invention.

FIG. 4 is a flowchart of the immediate movement default mode control process as a modification in accordance with one embodiment of the present invention.

FIG. 5 is a flowchart of the pre-movement notice default mode control process in accordance with one embodiment of the present invention.

FIG. 6 is a flowchart of the movement control process in accordance with one embodiment of the present invention.

FIG. 7 is an explanatory diagram showing the operation flow of each operation mode in accordance with one embodiment of the present invention.

FIG. 8 is an explanatory diagram showing the switching pattern of the operation mod in accordance with one embodiment of the present invention.

FIG. 9 is a flowchart of the immediate movement mode control process in accordance with one embodiment of the present invention.

FIG. 10 is a flowchart of the first pre-movement notice mode control process in accordance with one embodiment of the present invention.

FIG. 11 is a flowchart of the second pre-movement notice mode control process in accordance with one embodiment of the present invention.

FIG. 12 is a flowchart of the operation control process in accordance with one embodiment of the present invention.

FIG. 13 is a flowchart of the mode switching judgment process in accordance with one embodiment of the present invention.

### DETAILED DESCRIPTION OF EMBODIMENTS OF THE INVENTION

Embodiments of the present invention will be described in the following order with reference to a crane system for remotely operating an overhead crane that transports heavy objects in a factory or warehouse.
First Embodiment: A. System Configuration
   B. Example of Immediate Movement Mode as Default Mode
   C. Example of Pre-Movement Notice Mode as Default Mode
   D. Example of Two Shiftable Modes
Second Embodiment: E. Example of Multiple Shiftable Modes
   F. Example of Immediate Movement Mode
   G. Example of First Pre-Movement Notice Mode
   H. Example of Second Pre-Movement Notice Mode
   I. Control Process for Mode Switching
   J. Effects and Modifications

### First Embodiment

### A. System Configuration

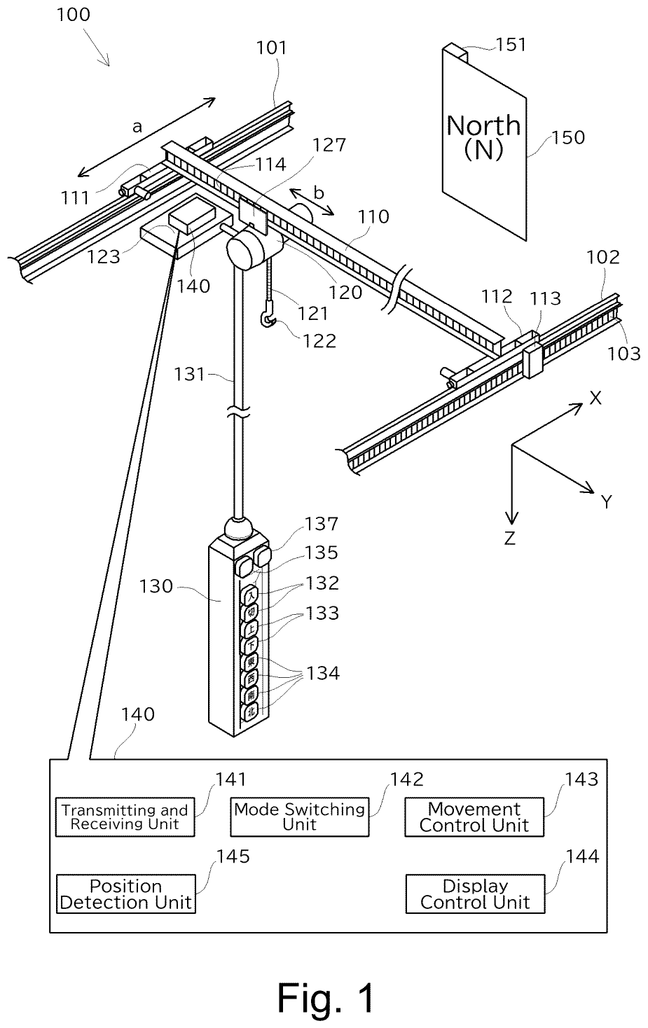

FIG. 1 is an explanatory diagram showing the configuration of the crane system 100. An overhead crane is a device that transports heavy loads by moving on a traveling rail installed in a factory according to the operator's operation. The overhead crane is provided with a hoist 120 as a movable object corresponding to a lifting device for transporting a suspended load. The hoist 120 can lift/down the suspended load by winding and lowering a wire 121 to which a hook 122 for hooking the suspended load is attached to the tip.

Operations such as winding up/down the wire 121 in the hoist 120 and moving the hoist 120 can be operated by a remote controller 130 connected by a cable 131. In the lower left of the figure, an enlarged view of the remote controller 130 is shown. As shown, the remote controller 130 includes pushbuttons 132 for turning on/off the power, pushbuttons 133 for winding up/down the wire 121, and four directional pushbuttons 134 for moving in four directions, east, west, north, and south.

Further, in the present embodiment, there are a plurality of operation modes such as a pre-movement notice mode that displays a pre-movement notice before moving the hoist 120 and an immediate movement mode that moves without the pre-movement notice. In order to switch these modes, a mode-switching button 135 is provided on an upper side of the remote controller 130, separately from other buttons mentioned above.

The mode switching button 135 is provided slightly to the left of the center of the remote controller 130. In this way, the push buttons 132, 133, and 134 for operating the crane can be operated with the right hand, while the mode switching button 135 can be operated with the left hand. According to the structure that makes these operations by different hands in this way, it is possible to suppress the mistake of accidentally switching modes during crane operation. Further, by providing a mode switching button 135 separate from the one for operating the crane, the operator has the advantage of being able to operate the crane without being aware of mode switching.

Other than the mode switching button 135, the operation mode may be switched using a dip switch, a slide switch, a jumper pin, a jumper wire, or the like provided inside or outside the remote controller. In this way, it is possible to suppress the possibility that the operation mode is accidentally switched during operation.

The pre-movement notice mode in the present embodiment can be an operation mode in which a pre-movement notice is displayed before the hoist 120 starts movement, and then the movement starts after a predetermined time has elapsed. Further, in a pre-movement notice mode, the movement starts after the pre-movement notice and a predetermined operation instruction is performed. In this case, an operation instruction button 137 for operation instruction may be provided. A pre-movement notice may be displayed when the direction button 134 is pressed while pressing the operation instruction button 137, and movement may be started when the operation instruction button 137 is released. Other than that, when the direction button 134 is pressed without pressing the operation instruction button 137, a pre-movement notice is displayed, and when the operation instruction button 137 is pressed, movement may be started.

The operation instruction button 137 is provided on the upper right side of the remote controller 130. By doing this, the finger can be smoothly moved to the operation instruction button 137 after pressing the direction button 134 for direction indication, and the operation efficiency is improved. Further, while the push buttons 132, 133, and 134 for operating the crane and the mode switching button 135 are provided on the left side, the operation instruction button 137 is provided on the right side. The positional relationship between the operation instruction button 137 and the mode switching button 135 may be interchangeable. They may be installed in other locations.

The remote controller 130 is not limited to the one shown in FIG. 1. For example, instead of the four direction buttons 134, the remote controller itself may be rotated about the central axis of the cylindrical housing to indicate the movement direction of the hoist 120. The remote controller 130 may use a wireless one instead of a wired one connected by a cable 131.

The hoist 120 has a display unit 123 mounted downward. As the display unit 123, a liquid crystal display was used in this embodiment, but an organic EL, an LED, or other display may be used. The display unit 123 displays the movement direction of the hoist 120 and other useful information during the operation of the crane to the operator or the like.

Although not shown in FIG. 1, a camera to capture the display contents of the display unit 123 may be further attached to the hoist 120. By providing a camera to capture the display unit 123, it is possible to judge abnormalities in the display content and display state of the display unit 123 from the captured image, and it is possible to prevent failure of the display unit 123 or respond quickly to the failure.

In this embodiment, wall display units 150 are provided on the walls of the facility where the overhead crane is installed. In the figure, only one provided on the north face is shown, but the display units 150 are installed in each direction of east, west, north, and south. In the present embodiment, since the remote controller 130 can indicate four directions, east, west, north, and south, the display units 150 are provided correspondingly thereto. If the direction of movement can be indicated in 8 directions, the display units 150 may be installed in 8 directions.

A receiver 151 is installed to each display unit 150, and a predetermined display operation is performed by receiving a wireless display instruction. Instead of wireless communication, display instructions may be received by wire. Either one of the display unit 123 and the display units 150 may be omitted.

The mechanism by which the hoist 120 moves will be described below. In the facility where the crane is installed, the running rails 101 and 102 are laid parallel and horizontally in the vicinity of the ceiling. On the running rails 101 and 102, saddles 111 and 112 are attached so that they can move along the arrow a by a motor power. A crane girder 110 is fixed to the saddles 111 and 112. The crane girder 110 is provided in a direction that is horizontal and perpendicular to the running rails 101 and 102. When the saddles 111 and 112 move along the arrow a, the crane girder 110 can also move as one.

The hoist 120 is attached to the crane girder 110 so that it can be moved in the direction of the arrow b along the crane girder 110 by a motor. Therefore, by combining the movement of the crane girder 110 along the arrow a and the movement of the hoist 120 along the arrow b, the hoist 120 can arbitrarily move the space between the traveling rails 101 and 102.

In the present embodiment, a mechanism for detecting the position of the hoist 120 is provided. As shown in the figure, a marker 103 for detecting a position is drawn on the running rail 102. Optically reading the marker 103 by the sensor 113 fixed to the saddle 112 makes it possible to detect the amount of movement of the saddle 112, and thus the position of the saddle 112 in the direction a. Similarly, a marker 114 for position detection is depicted on the crane girder 110. When the hoist 120 moves, optically reading the marker 114 by the sensor 127 fixed to the hoist 120 makes it possible to detect the amount of movement of the hoist 120, and thus the position of the hoist 120 in the direction b. As a result, based on the results read by the sensors 113 and 127, it is possible to detect the horizontal position coordinates (x, y) of the hoist 120. The detected position coordinates can be stored as a crane operation log and used for various purposes such as analysis of operation results, failure prediction, and so on.

The display on the display unit 123 and the display units 150 is controlled by a system control device 140 installed on the display unit 123. The installation location of the system control device 140 is optional, and may be fixed to a facility, an overhead crane, or the like, other than attaching to the hoist 120. The exchange of signals between the system control device 140, the display unit 123, and the display units 150 can be performed wirelessly or wired.

The system control device 140 is configured as a microcomputer internally having CPU and memory. In this embodiment, each function shown in the figure is realized by a computer program. Some or all of these functions may be configured by hardware.

The transmission/reception unit 141 exchanges signals between the system control device 140, the remote controller 130, the display units 123, 150, and the drive mechanism of hoist 120. When the position coordinates of the crane are stored as a log, the information may be transmitted to a server or the like.

The position detection unit 145 specifies the position coordinates of the hoist 120 based on the detection results of the sensors 113 and 127. The mode switching unit 142 controls switching between the pre-movement notice mode and the immediate movement mode. The movement control unit 143 controls the movement of the hoist 120 and operations such as winding up/down of the hook. The display control unit 144 controls the display contents of the display units 123 and 150. The system control device 140 may be provided with various other functions.

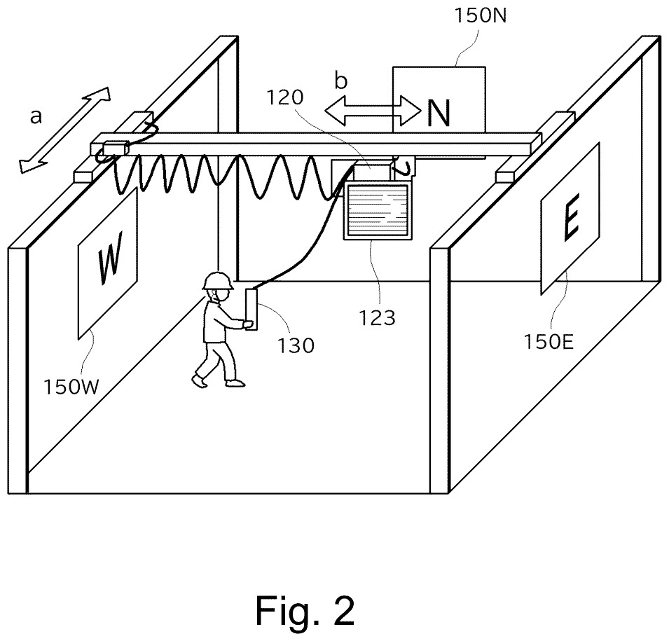

FIG. 2 is an explanatory diagram showing an example of the display of the crane system. An example case where the operator operates the remote controller 130 to move the crane to the east side is shown. The crane can be moved along the direction a and b, and when moving to the east side, it will move along the direction b.

When the operator operates the remote controller 130, an east-facing arrow indicating the direction of movement is displayed on the display unit 123 installed in the hoist 120. Further, the display unit 150E in the east, corresponding to the direction of movement, flashes. The display units 150N and 150W, except for the east direction, do not respond. Although not shown, the display unit in the south direction does not respond eighter. The display units that does not react may display characters such as north, west, south, etc., but may not blink, or may not display anything. Characters such as east, north, west, south, etc. may be drawn on the surface of each of the display units 150E, 150N, 150W, etc., and only the reacting display unit may be flashed.

The operator usually operates the crane by standing at the rear of the suspended load. When moving to the east, the operator operates the crane while standing in the west side of the suspended load and looking at the display unit 150E it. In such a state, if the display unit 150E on the east side reacts, the operator can easily confirm that the operation is correct. Further, in this state, if an incorrect operation is performed, the display unit other than the east side reacts and the display unit 150E in the east side does not react, so that the operator can easily notice that the operation is wrong.

### B. Example of Immediate Movement Mode as Default Mode

Hereinafter, the control of the display in this embodiment will be described. In this embodiment, two operation modes, a pre-movement notice mode and an immediate movement mode, are provided. The pre-movement notice mode is an operation mode in which a pre-movement notice is displayed according to instructing the direction of movement of the crane, and the movement starts after a predetermined time has elapsed. The immediate movement mode is an operation mode in which the movement starts without waiting for the above-described pre-movement notice and a predetermined time lapse. These modes of operation can be used in combination in various aspects.

First, an example of a control in which the immediate movement mode is the default or primary operation mode, and can be switched to the pre-movement notice mode when the mode switching button 135 of the remote controller 130 is pressed (hereinafter referred to as “immediate movement default mode control process”) will be described.

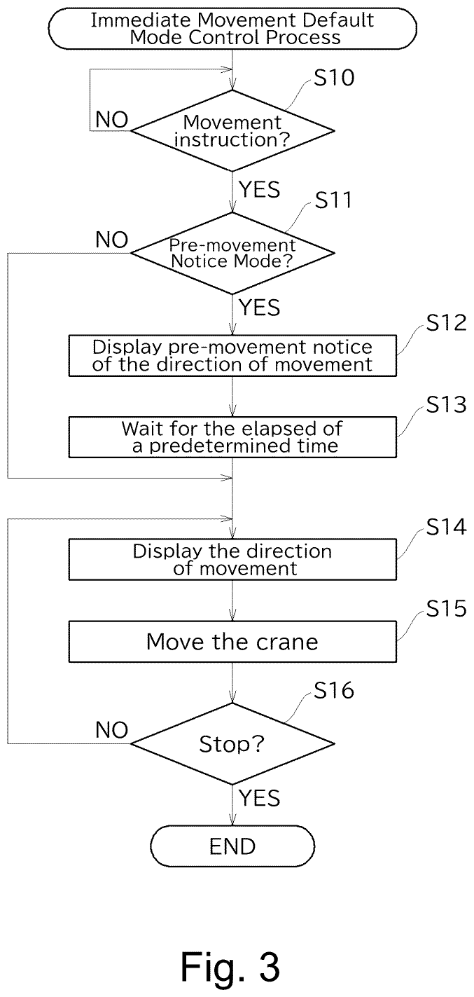

FIG. 3 is a flowchart of the immediate movement default mode control process. It is a process executed by the system control device 140 according to the operation of the remote controller 130. The system control device 140 waits until a movement instruction is given (step S10). When a movement instruction is given, by pressing the direction button 134 representing the direction of movement or the like (step S10), the system control device 140 determines whether the pre-movement notice mode is in effect (step S11). In this embodiment, if the mode switching button 135 of the remote controller 130 is pressed, it is determined that the pre-movement notice mode is in effect, otherwise it is determined that the immediate movement mode is in effect. That is, if the operation is performed as usual without pressing the mode switching button 135, it operates in the immediate movement mode, and when the operator desires to display a pre-movement notice, the operator issues a movement instruction while the mode switching button 135 is being pressed.

When it is determined that the pre-movement notice mode is in effect (step S11), the system control device 140 displays a pre-movement notice of the moving direction (step S12). The pre- movement notice is performed by displaying an arrow on the display unit 123 as shown in FIG. 2 and making the display unit 150 corresponding to the moving direction react. Thereafter, the system control device 140 waits for a predetermined time to elapse (step S13). This predetermined time can be arbitrarily set as a time for the operator to confirm the pre-movement notice, and can be about 2 to 3 seconds. This predetermined time may be adjustable.

When the predetermined time has elapsed, the system control device 140 displays the direction of movement on the display units 123 and 150 (step S14) and moves the crane (step S15). The movement of the crane is repeated until a stop instruction is indicated by the remote controller 130 (step S16), that is, until the button indicating the direction of movement is released or an emergency stop is indicated. It should be noted that the display for the movement of the crane (step S14) and display for the pre-movement notice (step S12) may be the same, or the display mode such as color, display size, and flashing may be changed. If the display mode is changed, there is an advantage that it calls attention to the fact that it is moving.

When it is determined that the pre-movement notice mode is not set (step S11), that is, when it is determined that the system is in the immediate movement mode, the display and movement in steps S14 to S16 are performed, skipping steps S12 and S13.

According to the above embodiment, responsiveness and workability can be ensured by performing normal operations in the immediate movement mode, and safety can be ensured by switching to the pre-movement notice mode as necessary when transporting a heavy object or the like.

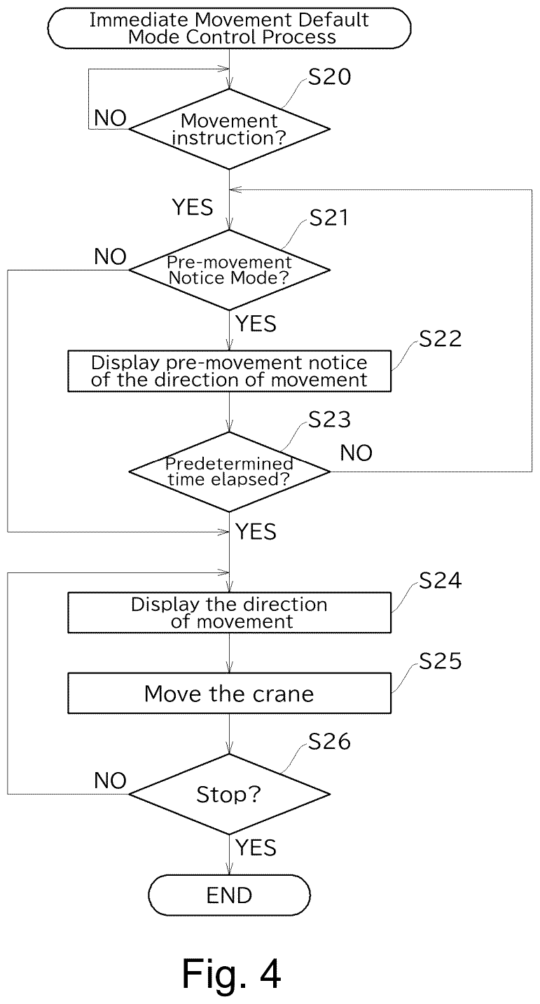

FIG. 4 is a flowchart of an immediate movement default mode control process as a modification. The system control device 140 waits until a movement instruction is given (step S20). And when a movement instruction is given (step S20), the system control device 140 determines whether it is in a pre-movement notice mode (step S21). These processes are the same as those described with respect to FIG. 3.

When it is determined that the pre-movement notice mode is in effect (step S21), the system control device 140 displays a notice of the direction of movement (step S22). Then, it is determined if a predetermined time has elapsed (step S23). If the predetermined time has not elapsed, the process returns to the determination in step S21.

Therefore, even if the movement instruction is issued in the pre-movement notice mode while the mode switching button 135 is being pressed, the operation mode can be immediately switched to the immediate movement mode by releasing the mode switching button 135 before the predetermined time has elapsed.

When the predetermined time has elapsed or the pre-movement notice mode is canceled before the predetermined time has elapsed, the system control device 140 displays the direction of movement and moves the crane until a stop instruction is indicated (steps S24 to S26). The same applies when the system is operated in the immediate movement mode is from the beginning (step S21).

According to the modification, since the pre-movement notice mode can be canceled at any time, the responsiveness and workability can be further improved. In addition, in order to ensure minimum safety, a limit may be set on the cancellation of the pre-movement notice mode. For example, in step S22 of FIG. 4, a waiting time shorter than the predetermined time of step S23 may be set, and only after the waiting time has elapsed, the process may proceed to step S23. In this way, a pre- movement notice is displayed during at least the waiting time, so a minimum level of safety can be ensured.

### C. Example of Pre-Movement Notice Mode as Default Mode

Next, an example of control in which the pre-movement notice mode is default and is switched to the immediate movement mode when the mode switching button 135 of the remote controller 130 is pressed (hereinafter referred to as “pre-movement notice default mode control process”) will be described.

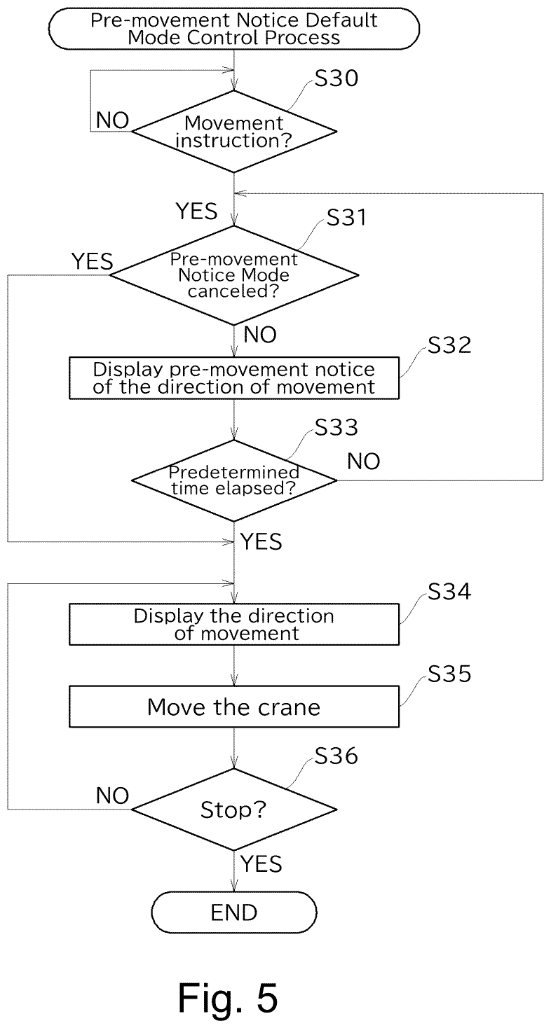

FIG. 5 is a flowchart of the pre-movement notice default mode control process. The system control device 140 waits until a movement instruction is given (step S30). When a movement instruction is given (step S30), the system control device 140 determines whether the pre-movement notice mode has been canceled (step S31). In this process, if the mode switching button 135 of the remote controller 130 is pressed, it is determined that the pre-movement notice mode is canceled, and if not, it is determined that the system is in the pre-movement notice mode. That is, if the operation is performed as usual without pressing the mode switching button 135, the system operates in the pre- movement notice mode, and when the operator wants to cancel the pre-movement notice, the operator presses the mode switching button 135 and performs a movement instruction.

When it is determined that the pre-movement notice mode has not been canceled (step S31), the system control device 140 displays a pre-movement notice of the direction of movement (step S32). Then, determine whether a predetermined time has elapsed (step S33). If the predetermined time has not elapsed, the process returns to the determination in step S31. Therefore, the pre-movement notice mode can be canceled at any time by pressing the mode switching button 135 before the predetermined time has elapsed.

Alternatively, step S13 of FIG. 3 may be applied, and the pre-movement notice mode may not be canceled.

When the predetermined time has elapsed or the pre-movement notice mode is canceled, the system control device 140 displays the direction of movement and moves the crane until a stop instruction is indicated (steps S34 to S36). These processes are the same as those described with respect to FIG. 3.

According to the above embodiment, since the normal operation is performed in the pre-movement notice mode, the safety of the crane can be ensured. On the other hand, since the pre- movement notice mode can be canceled as necessary and switched to the immediate movement mode, it is possible to ensure responsiveness and workability.

### D. Example of Two Shiftable Modes

FIGS. 3 and 4 show an example in which the immediate movement mode is set as the default, while FIG. 5 shows an example in which the pre-movement notice mode is set as the default. In this embodiment, although one of the control processes may be selected and applied, as shown in the following modifications, it may be possible to shift the default setting.

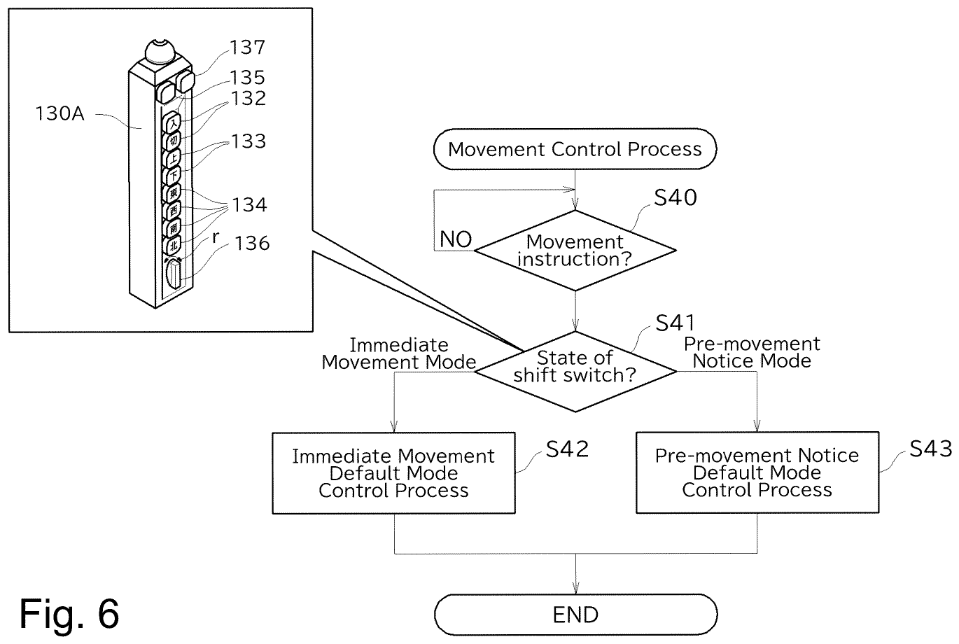

FIG. 6 is a flowchart of a modified movement control process. The upper left of the figure shows the remote controller 130A of the modification. In addition to each of the buttons described in FIG. 1, the remote controller 130A is provided with a shift switch 136. The shift switch 136 may be rotated like an arrow r, and can switch between the immediate movement default mode and the pre-movement notice default mode by rotating left or right (clockwise or counter-clockwise).

In the modified movement control process, the system control device 140 waits until a movement instruction is given (step S40). When a movement instruction is given (step S40), the system control device 140 determines which one of the immediate movement mode or the pre- movement notice mode is to be set as default operation mode according to the state of the shift switch 136 (step S41).

Then, when the immediate movement mode is set as the default, the immediate movement default mode control process is executed (step S42). The control process are as described in FIGS. 3 and 4. When the pre-movement notice mode is set as the default, the pre-movement notice default mode control process is executed (step S43). The control process is as described in FIG. 5. By doing this, it is possible to switch the immediate movement default mode control process and the pre- movement notice default mode control process by switching the shift switch 136, and it is possible to improve convenience.

### Second Embodiment

Next, the crane system as a second embodiment will be described. The configuration of the crane system of the second embodiment is the same as that of the first embodiment described in FIGS. 1 and 2. In the first embodiment, an example of two switchable operation modes: the pre- movement notice mode and the immediate movement mode was described. In the second embodiment, an example of a plurality of switchable operation modes, which is not limited to those two modes, will be described.

### E. Example of Multiple Shiftable Modes

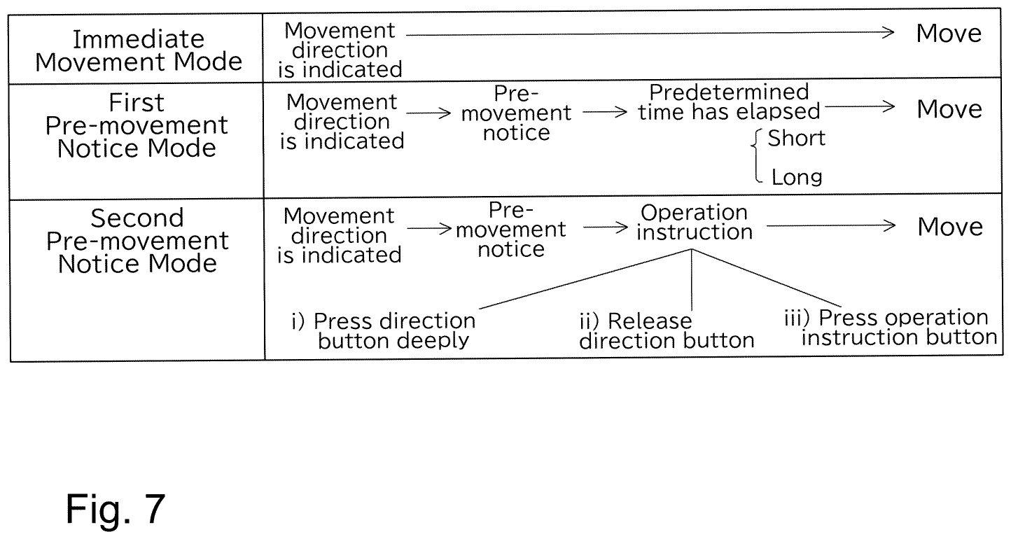

FIG. 7 is an explanatory diagram showing a process flow of each operation mode. In the second embodiment, three operation modes of immediate movement mode, first pre-movement notice mode, and second pre-movement notice mode are used. Some operation modes may be omitted, or more operation modes may be used.

As shown in the top row of the figure, in the immediate movement mode, the crane moves immediately without pre-movement notice when the direction of movement is indicated.

As shown in the middle row of the figure, in the first pre-movement notice mode, a pre-movement notice is displayed when the movement direction is indicated. Then, after a predetermined time has elapsed, the crane moves automatically. The predetermined time can be arbitrarily set, and the first pre-movement notice mode can further be divided into two modes: a first short pre-movement notice mode in which the crane moves after a first predetermined time has elapsed, and a first long pre-movement notice mode in which the crane moves after a second predetermined time longer than the first predetermined time has elapsed.

As shown in the bottom row of the figure, in the second pre-movement notice mode, a pre-movement notice is displayed when a movement direction is given. Then, when the operator gives an operation instruction, the crane starts moving. The operation instruction can be made by various methods. For example, the direction button 134 may be pressed in two stages, and when pressed lightly it becomes a direction indication, and when pressed deeper, it becomes an operation instruction. A direction instruction may be made by pressing the direction button 134 while the operation instruction button 137 is being pressed, and a subsequent operation instruction may be made by releasing the operation instruction button 137 that has been pressed. Alternatively, pressing the direction button 134 without pressing the operation instruction button 137 may result in a direction indication, and thereafter, pressing the operation instruction button 137 may result in an operation instruction. The operation instruction can take various other aspects. It should be noted that any one of the above-described operation instruction methods shown in the figure may be employed, or may be selected from a plurality of operation instruction methods.

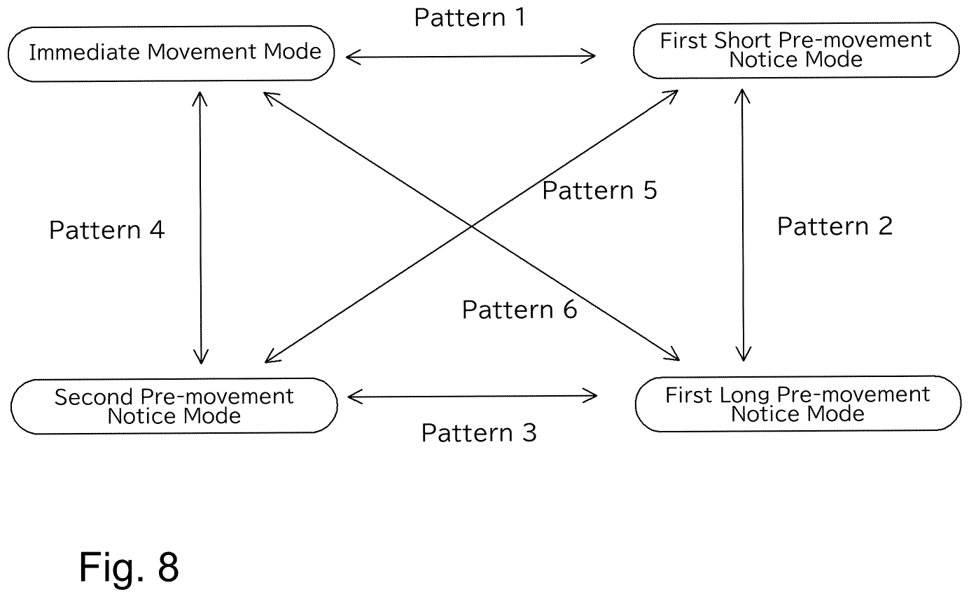

FIG. 8 is an explanatory diagram showing the switching pattern of a plurality of operation modes. It is assumed that there are a total of six possible switching patterns.

Pattern 1 is a switching between the immediate movement mode and the first short pre-movement notice mode. As described in the first embodiment, switching between the two modes can satisfy safety and responsiveness requirements depending on the situation.

Pattern 2 is a switching between the first short pre-movement notice mode in which the time from the pre-movement notice to the start of movement is short (a first time period), and the first long pre-movement notice mode in which the time from the pre-movement notice to the start of movement is long (a second time period longer than the first time period). For example, in the case of transporting a heavy load, it is preferable to start moving after carefully confirming safety after a pre- movement notice is displayed, so it is preferable to have a long time period until the start of movement. On the other hand, when transporting a relatively light load or empty cargo, the shorter the time period before the start of movement, the higher the workability. According to Pattern 2, it is possible to change the time period until the start of movement depending on the scene. The two operation modes can be switched according to various conditions, such as the type of suspending load and the skill level of the operator.

Pattern 3 is a switching between the first long pre-movement notice mode and the second pre-movement notice mode. The first long pre-movement notice mode has the advantage that a movement can be started without giving an operation instruction, whereby the complexity of operation can be avoided. On the other hand, the second pre-movement notice mode has the advantage that a movement can be started at any timing by giving an operation instruction. According to Pattern 3, these advantages can be selectively used depending on the situation. For example, the first long pre- movement notice mode is usually used, and the second pre-movement notice mode may be used when moving an empty cargo or when operating by a skilled operator.

Pattern 4 is a switching between the second pre-movement notice mode and the immediate movement mode. As in the first embodiment, switching between the two modes can satisfy safety and responsiveness requirements depending on the situation.

Pattern 5 is a switching between the first short pre-movement notice mode and the second pre-movement notice mode. Switching between the two modes has the same advantages as Pattern 3.

Pattern 6 is a switching between the immediate movement mode and the first long pre-movement notice mode. As in the first embodiment, switching between the two can satisfy safety and responsiveness requirements depending on the situation.

It is not necessary to enable all six patterns described above, and only part of the operation mode switching may be performed. Further, it may be switchable between three or more operation modes.

Hereinafter, the control process in each operation mode will be described, and then the switching will be described.

### F. Examples of Immediate Movement Mode

A control process for the crane when the system is operated in the immediate movement mode (hereinafter referred to as “immediate movement mode control process”) will be described.

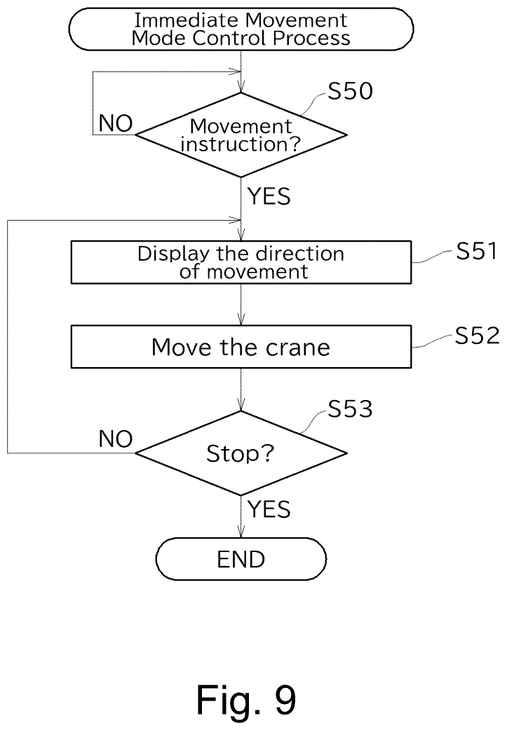

FIG. 9 is a flowchart of the immediate movement mode control process. As shown in FIG. 9, the system control device 140 waits until a movement instruction is given (step S50). When the movement instruction is given (step S50), the system control device 140 displays the direction of movement on the display units 123 and 150 (step S51) and moves the crane (step S52). This display is not a pre-movement notice before the move, but is performed during the movement, and can be omitted. The movement of the crane is repeated until a stop instruction is issued by the remote controller 130 (step S53).

### G. Examples of First Pre-Movement Notice Mode

A control process for the crane when the system is operated in the first pre- movement notice mode (hereinafter referred to as “first pre-movement notice mode control process”) will be described.

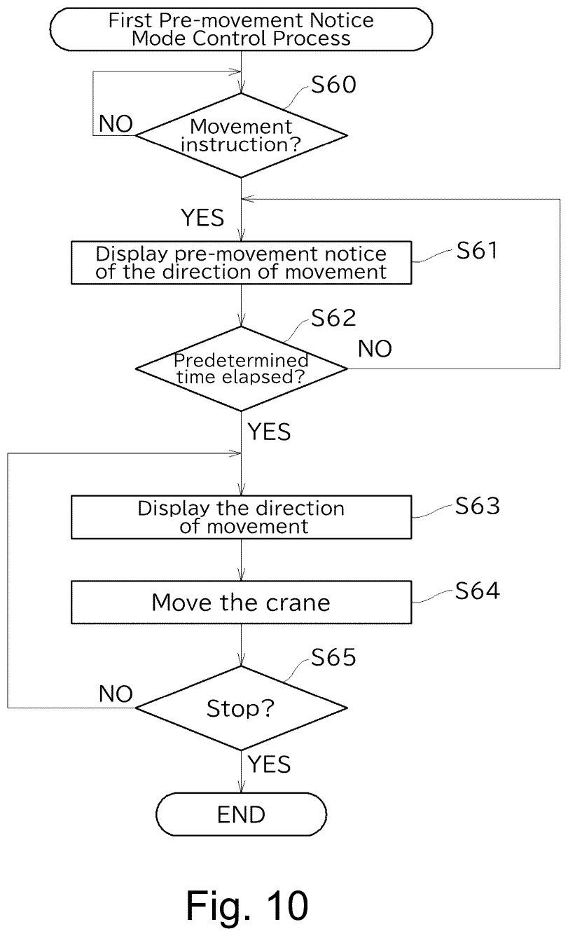

FIG. 10 is a flowchart of the first pre-movement notice mode control process. The system control device 140 waits until a movement instruction is given (step S60). When the movement instruction is given (step S60), the system control device 140 displays a movement direction in advance (step S61). Then, determine whether a predetermined time has elapsed (step S62). If the predetermined time has not elapsed, the pre-movement notice is kept displayed by returning to step S61. When a predetermined time has elapsed, the system control device 140 displays the movement direction and moves the crane until a stop is instructed (steps S63 to S65).

The predetermined time in step S62 is a preset time. Only one predetermined time may be set, or multiple predetermined times may also be set. When a plurality of predetermined times are set, for example, an operation mode with a short predetermined time becomes the first short pre- movement notice mode, and an operation mode with a long predetermined time becomes the first long pre-movement notice mode.

### H. Examples of Second Pre-Movement Notice Mode

A control process for the crane when the system is operated in the second pre- movement notice mode (hereinafter referred to as “second pre-movement notice mode control process”) will be described.

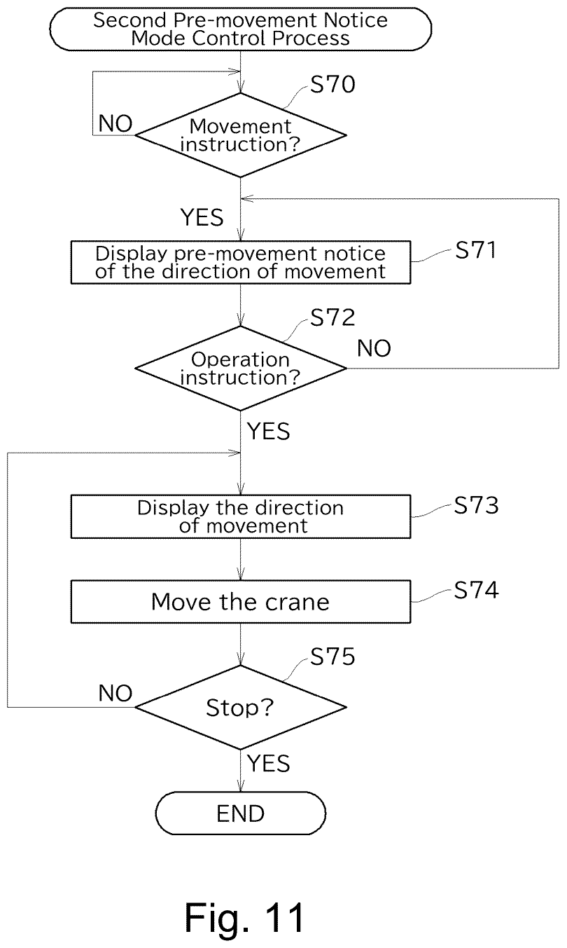

FIG. 11 is a flowchart of the second pre-movement notice mode control process. As shown in FIG. 11, the system control device 140 waits until a movement instruction is given (step S70). When the movement instruction is given (step S70), the system control device 140 displays a movement direction in advance (step S71). Then, it is determined whether there is an operation instruction (step S72). When there is no operation instruction, the process returns to step S71 and the pre-movement notice is maintained. When an operation instruction is given, the system control device 140 displays the movement direction and moves the crane until a stop instruction is given (steps S73 to S75).

### I. Control Process for Mode Switching

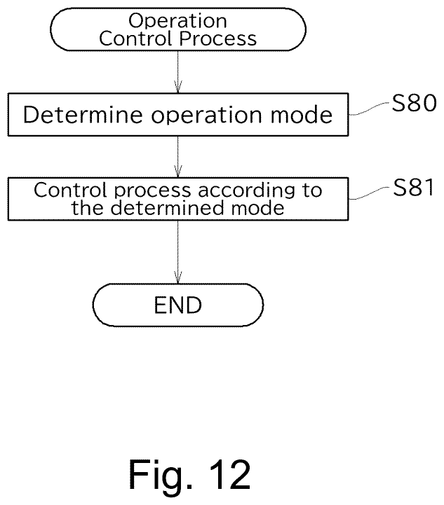

FIG. 12 is a flowchart of the operation control process. This process is for controlling the operation of the crane by allowing switching among a plurality of operation modes.

When the process starts, the system control device 140 determines which operation mode should to be executed from among a plurality of operation modes (step S80). If no particular operation mode is specified by the operator, an operation mode which is set as the default will be executed. If the operator selects one of the operation modes or instructs switching the operation mode to a particular operation mode, the selected or instructed operation mode is executed.

Switching of the operation mode can be performed by operating the mode switching button 135. For example, each time the mode switching button 135 is pressed, the immediate movement mode, the first pre-movement notice mode, and the second pre-movement notice mode may be switched sequentially (toggled). Instead, as a mode switching button, three push buttons corresponding to the immediate movement mode, the first pre-movement notice mode, and the second pre-movement notice mode may be provided, and one of them may be pressed to directly switch to the corresponding operation mode. It may be switchable by the shift switch 136 shown in FIG. 6.

The system control device 140 then executes a control process according to the determined mode (step S81). The control process in each operation mode is as described in FIGS. 9 to 11. The determination of the operation mode may be performed only at the time when the process is started, or may be performed during the control process in each operation mode. In the latter case, the presence or absence of an operation mode switching instruction is continuously detected during the control process in each operation mode, and when an operation mode switching instruction is detected in the middle of the control operation, the process may be returned to the determination in step S80.

According to the above operation control process, the operation mode can be switched according to the instruction of the operator, and the operation of the crane can be controlled according to each operation mode.

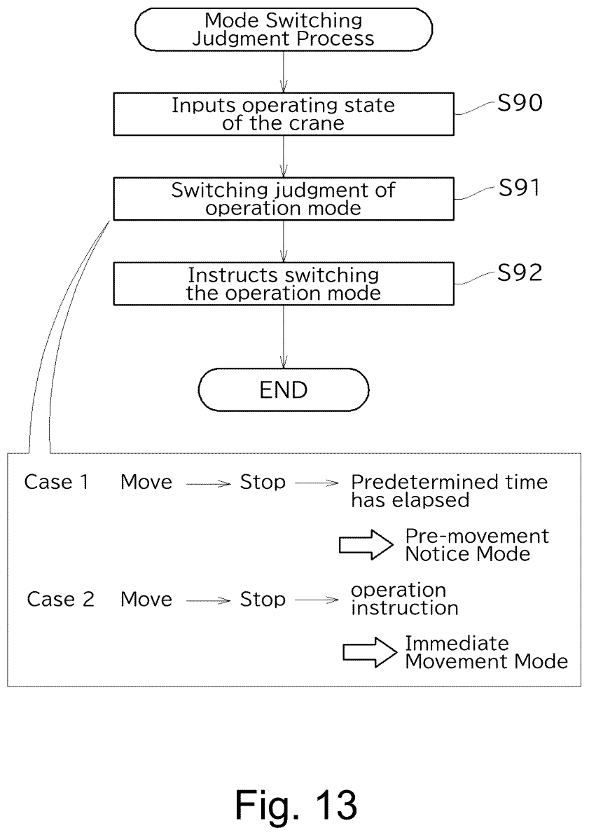

In addition to switching the operation mode according to the operation of the operator, switching of the operation mode can be performed automatically. FIG. 13 is a flowchart of a mode switching judgment process, in which the system control device 140 automatically switches the operation mode when a predetermined condition is satisfied. When the process starts, the system control device 140 inputs the operating state of the crane (step S90). Then, the system control device 140 automatically determines whether to switch the operation mode according to the operating state of the crane (step 91), and then instruct to switche the operation mode to the determined operation mode determined in step 91 (step 92). The control process in each operation mode is the same as that described in FIGS. 9 to 11.

In addition, the mode switching determination process of FIG. 13 may be performed only at the time when the process is started, or may be performed during the control process in each operation mode. In the latter case, the mode switching determination process may be appropriately executed during the control process in each operation mode, and the operation mode switching determination may be performed in the middle.

In this embodiment, it is assumed that the operation mode can be automatically switched in the following two cases.

In Case 1, when a predetermined time has elapsed after the crane is stopped, the switching to the pre-movement notice mode is performed. Switching to another operation mode may also be performed. An example of a case in which no operation is performed for a predetermined time after the movement is stopped may be such a situation that the crane has finished transporting a suspended load and is in a standby state. Therefore, the operation mode is preferably set to a pre- movement notice mode which provides a high level of safety and is a suitable operation mode for starting a new operation. By performing the switching in Case 1, for example, when the operator who operated the crane in the immediate movement mode resumes the operation after a certain period of time, even if the operator had forgotten to change/switch the operation mode, it is possible to avoid such a situation in which the crane starts moving in the immediate movement mode.

In Case 2, when an operation is performed within a predetermined time after the crane is stopped, switching to the immediate movement mode is performed. Switching to another operation mode may be performed. By this switching to the immediate movement mode, for example, a trailing notch or a reverse notch can be performed in the immediate movement mode without any mode switching operation, and thus this is useful to improve responsiveness.

Therefore, the crane's operating state used in steps S90 and S91 is information necessary to perform these determinations. For example, the information includes whether the crane is moving, the elapsed time after the movement is stopped, and the like. In addition, whether the crane has been winding up or down may be used as the information to be considered.

The predetermined time in Case 1 and the predetermined time in Case 2 need not be the same, and a value suitable for each judgment may be arbitrarily set.

### J. Effects and Modifications

According to the crane system of the embodiments described above, by making the plurality of operation modes appropriately switchable, it is possible to achieve both the safety of the crane and the responsiveness and workability.

The present invention does not have to be provided with all of the various features described in the examples, and some of them may be omitted or combined as appropriate. Furthermore, the present invention is not limited to the described examples, but can take various modifications. For example, the present invention is applicable to various types of cranes, not limited to overhead cranes. It can also be applied to movable objects other than cranes.

Furthermore, these operation modes may be simply switched each time the mode switching button 135 is pressed, without setting any of the pre-movement notice mode, immediate movement mode, or the like as default as described in the above examples.

What is claimed is:

1. A remote-control system for remotely controlling a movable object by wire or wirelessly, the system comprising:
a remote controller configured to be operated by an operator for remotely controlling movement of the object;
a display unit provided visibly to the operator who operates the remote controller, the display unit displaying an indication relating to movement of the object;
a system control device configured to control the movement of the object and the indication displayed on the display unit according to an operation of the remote controller;
wherein the system control device has a plurality of operation modes switchable therebetween, the plurality of operation modes being different from one another with respect to at least one of presence or absence of a pre-movement notice before the object is moved, and a condition to start moving the object.

2. The remote-control system according to claim 1, wherein the plurality of operation modes include at least one of:
a first pre-movement notice mode in which the system control device displays a movement direction of the object on the display unit according to the operation of the remote controller, followed by moving the object after passing of a predetermined time;
a second pre-movement notice mode in which the system control device displays the movement direction of the object on the display unit according to the operation of the remote controller, receives an operation instruction, then moves the object in accordance with the operation instruction; and
an immediate movement mode in which the system control device immediately moves the object according to the operation of the remote controller.

3. The remote-control system according to claim 2, wherein the remote controller includes an operation unit for issuing the operation instruction.

4. The remote-control system according to claim 2, wherein, in the immediate movement mode, the system control device also displays the movement direction of the object on the display unit while moving the object.

5. The remote-control system according to claim 1, wherein the plurality of operation modes include:
a pre-movement notice mode in which the system control device displays a movement direction of the object on the display unit according to an operation of the remote controller, then moves the object when a predetermined condition is satisfied; and
an immediate movement mode in which the system control device immediately moves the object according to the operation of the remote controller.

6. The remote-control system according to claim 1, wherein the plurality of operation modes include:
a short pre-movement notice mode in which the system control device displays a movement direction of the object on the display unit according to an operation of the remote controller, followed by moving the object after passing of a first predetermined time; and
a long pre-movement notice mode in which the system control device displays the movement direction of the object on the display unit according to the operation of the controller, followed by moving the object after passing of a second predetermined time longer than the first predetermined time.

7. The remote-control system according to claim 1, wherein the remote controller includes:
an operation unit for issuing an operation instruction of the object; and
a switching unit for switching the plurality of modes.

8. The remote-control system according to claim 1, wherein the system control device is further configured to switch from one operation mode to another operation mode when a predetermined condition is satisfied.

9. The remote-control system according to claim 8, wherein the predetermined condition includes absence of remote-control operation for a predetermined time after the object stopped moving.

10. The remote-control system according to claim 9, wherein the system control device is further configured to switch into a pre-movement notice mode when the predetermined condition is satisfied, the system control device in the pre-movement notice mode displaying a movement direction of the object on the display unit according to an operation of the remote controller, followed by moving the object when the condition to start moving the object is satisfied.

11. The remote-control system according to claim 8, wherein the predetermined condition includes presence of a remote-control operation within a predetermined time after the object stopped moving.

12. The remote-control system according to claim 11, wherein the system control device is further configured to switch into an immediate movement mode when the predetermined condition is satisfied, the system control device in the immediate movement mode immediately moving the object according to the remote-control operation.

13. The remote-control system according to claim 1, wherein the system control device is capable of switching from one of the plurality of operation modes into another even while operating in the one operation mode.

14. The remote-control system according to claim 1, wherein an operation of the remote controller to instruct a movement direction of the object is also an operation to start moving the object.

15. The remote-control system according to claim 1, wherein the system control device is configured, as a default setting, to operate in one of:
a first pre-movement notice mode in which the system control device displays a movement direction of the object on the display unit according to an operation of the remote controller, followed by moving the object after passing of a predetermined time;
a second pre-movement notice mode in which the system control device displays the movement direction of the object on the display unit according to the operation of the remote controller, receives an operation instruction, then moves the object in accordance with the operation instruction; and
an immediate movement mode in which the system control device immediately moves the object according to the operation of the remote controller.

16. The remote-control system according to claim 1, wherein the system control device is capable of switching from one default operation mode to another default operation mode among the plurality of operation modes.

17. The remote-control system according to claim 1, wherein the display unit includes a movable display attached to the object and moving together with the object.

18. The remote-control system according to claim 1, wherein the display unit includes at least one fixed display installed at at least one location in a space where the object moves.

19. The remote-control system according to claim 18,
wherein the display unit includes a plurality of fixed displays installed in a plurality of locations corresponding to movable directions of the object, and
wherein the system control device is further configured to make one of the plurality of fixed displays installed at a location corresponding to a movement direction of the object react, the movement direction being indicated by an operation of the remote controller.

20. The remote-control system according to claim 1, wherein the object is an overhead crane.

21. A remote-control method for remotely controlling a movable object by wire or wirelessly, the method, performed by a computer, comprising:
receiving a signal for moving the object from a remote controller for remotely controlling movement of the object;
displaying an indication relating to the movement of the object on a display unit provided visibly to an operator who operates the remote controller according to the received signal; and
controlling the movement of the object and the indication displayed on the display unit according to an operation of the remote controller and an operation mode which is one of a plurality of operation modes different from one another with respect to at least one of presence or absence of a pre- movement notice before the object is moved, and a condition to start moving the object, the controlling including:
switching among the plurality of operation modes.
